(19) United States
(12) Patent Application Publication
(10) Pub. No.: US 2024/0028456 A1
(43) Pub. Date: Jan. 25, 2024

(54) UNATTENDED SNAPSHOT REVERSION FOR UPGRADES

(71) Applicant: VMWARE, iNC, Palo Alto, CA (US)

(72) Inventors: TOMO VLADIMIROV SIMEONOV, Sofia (BG); Ivaylo Radoslavov Radev, Sofia (BG); Rajendra Kulkarni, Bangalore (IN); Dhananjaya Channapura Narayanappa, Bangalore (IN)

(21) Appl. No.: 17/974,687

(22) Filed: Oct. 27, 2022

(30) Foreign Application Priority Data
Jul. 22, 2022 (IN) 202241042171

(51) Int. Cl. G06F 11/14; G06F 9/50

(52) U.S. Cl. CPC G06F 11/1433; G06F 9/5077; G06F 2201/84

(57) ABSTRACT

The present disclosure is related to methods, systems, and machine-readable media for unattended snapshot reversion for upgrades. A request to upgrade a virtual computing instance (VCI) in a software-defined datacenter (SDDC) can be received. A snapshot of the VCI can be created, wherein the snapshot excludes a predefined storage partition associated with the VCI. An upgrade of the VCI can be executed. Executing the upgrade can include performing a plurality of upgrade steps and storing, in the partition, information pertaining to the execution of the upgrade. The snapshot can be reverted to responsive to a cancellation of the upgrade. The upgrade of the VCI can be re-executed from the snapshot. Re-executing the upgrade can include performing a different plurality of upgrade steps determined based on the information pertaining to the execution of the upgrade.

### RELATED APPLICATIONS

Benefit is claimed under 35 U.S.C. 119(a)-(d) to Foreign Application Serial No. 202241042171 filed in India entitled “UNATTENDED SNAPSHOT REVERSION FOR UPGRADES”, on Jul. 22, 2022, by VMware, Inc., which is herein incorporated in its entirety by reference for all purposes.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Snapshots may be utilized in a software defined data center to provide backups and/or disaster recovery. For instance, a snapshot can be used to revert to a previous version or state of a VCI.

### BRIEF DESCRIPTION OF THE DRAWINGS

FIG. 1 is a diagram of a host and a system for unattended snapshot reversion for upgrades according to one or more embodiments of the present disclosure.

FIG. 2 illustrates a method for unattended snapshot reversion for upgrades according to one or more embodiments of the present disclosure.

FIG. 3 is a diagram of a system for unattended snapshot reversion for upgrades according to one or more embodiments of the present disclosure.

FIG. 4 is a diagram of a machine for unattended snapshot reversion for upgrades according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

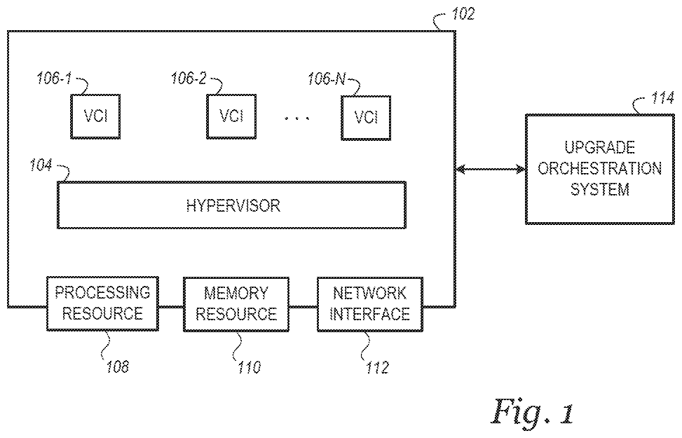

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

A VCI snapshot (referred to herein simply as “snapshot”) is a copy of a disk file of a VCI at a given point in time. A snapshot can preserve the state of a VCI so that it can be reverted to at a later point in time. The snapshot can include memory as well. In some embodiments, a snapshot includes secondary storage, while primary storage is optionally included with the snapshot. A snapshot can store changes from a parent snapshot (e.g., without storing an entire copy of the parent snapshot). A snapshot includes one or more extents. An extent is a contiguous area of storage reserved for a file in a file system. An extent can be represented, for instance, as a range of block numbers. Stated differently, an extent can include one or more data blocks that store data. Snapshots provide filesystems the ability to take an instantaneous copy of the filesystem. An instantaneous copy allows the restoration of older versions of a file or directory from an accidental deletion, for instance. Snapshots also provide the foundation for other disaster recovery features, such as backup applications and/or snapshot-based replication.

During an upgrade (e.g., to a VCI), a backup may be desired to ensure that there is a safe point to return to in case of a failure or cancellation of the upgrade. Such a backup could be created using VCI snapshot, file-based backup, Logical Volume Manager (LVM) snapshot, etc. Typically, in previous approaches, these are created from outside the upgraded machine, either manually or by some automation. Additionally, such a backup is created before the upgrade and often requires downtime to ensure no data is lost. As a result, previous approaches have difficulties associated with external high-level orchestration and/or time. A better option would be to create the backup from the upgrade orchestration itself, thus simplifying the operations and causing as little disruption to the customer as possible. However, this may be difficult because it risks the system being inconsistent once a restore happens. For instance, the upgrade orchestration may “think” it is in the middle of a backup, instead of a restore, because in previous approaches it cannot keep information between the pre-revert and post-revert states. Furthermore, the information on why a restore was/is needed may not be preserved as it is not typically part of the backup.

Other previous approaches to solve the problem described above include moving all of the backup logic outside the machine and never triggering or managing it from the machine itself. The downside is that there is a different entity that needs to be part of the backup/restore, which poses additional problems associated with communication and synchronization. Some previous approaches utilize mirror partitions where new bits are installed in one partition and the other is used as a backup. The primary problem with such an approach is that it does not work for all scenarios, such as in non-disruptive upgrades, and requires double the storage.

Embodiments of the present disclosure include a process of taking and restoring backups as part of an upgrade, allowing automated backups and restores as part of upgrades. Embodiments herein do not require an external entity to trigger those operations as the upgrade process itself can trigger them. Stated differently, a snapshot of a VCI can be taken by (e.g., from inside) the VCI itself (e.g., instructions to create a snapshot of the VCI can be executable by the VCI). Embodiments herein can allow unattended reversion for upgrades for methods of restoring that can restore both configuration and binaries (e.g., LVM and VCI snapshots). An upgrade orchestrator can drive the upgrade process. The upgrade orchestrator can take the VCI's backup as part of its workflow at an appropriate time for a given upgrade, thereby reducing downtime and/or disruption. When taking a backup, embodiments herein exclude (e.g., omit) a predefined storage partition for later use. The excluded partition can store any information needed after and/or during the restore to allow a failed upgrade to subsequently succeed. Such information can include an indication that a restore has been performed. In some embodiments, such information can include logs, messages, etc. that can be used later for debugging or information that may be helpful to a customer (herein referred to as “user-relevant information”) in determining what may have gone wrong with an upgrade. The upgrade orchestrator can monitor the partition and use it to determine where the process is at any given time (e.g., standard workflow or restore workflow) without the need for user intervention or external entities. With this approach, an automated backup/restore mechanism can be added as part of an upgrade process that uses VCI and/or LVM snapshotting.

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for unattended snapshot reversion for upgrades according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with an upgrade orchestration system 114. An example of the upgrade orchestration system 114 is illustrated and described in more detail below. In some embodiments, the upgrade orchestration system 114 can be a server, such as a web server.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

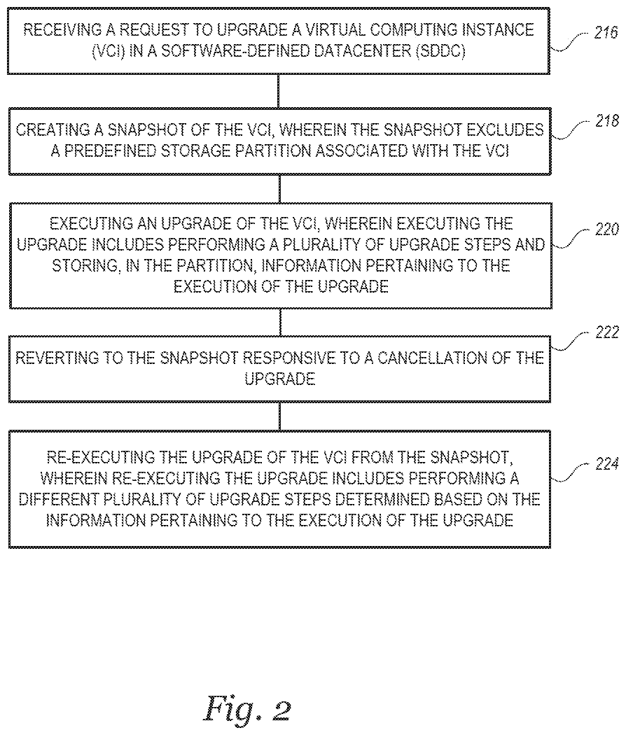

FIG. 2 illustrates a method for unattended snapshot reversion for upgrades according to one or more embodiments of the present disclosure. At 216, the method includes receiving a request to upgrade a virtual computing instance (VCI) in a software-defined datacenter (SDDC).

At 218, the method includes creating a snapshot of the VCI, wherein the snapshot excludes a predefined storage partition associated with the VCI. The snapshot can be a VCI snapshot. The snapshot can be a Logical Volume Manager (LVM) snapshot. In some embodiments, more than one (e.g., two) predefined storage partitions can be excluded from the snapshot. In some embodiments, this predefined storage partition can be a dedicated lifecycle partition. The lifecycle partition may be used to store large files, it does not get updated often, and leaving information from before a reversion does not negatively affect the system. It is noted that the lifecycle partition is only used as an example and that embodiments herein are not limited to a particular partition being excluded from snapshots.

At 220, the method includes executing an upgrade of the VCI, wherein executing the upgrade includes performing a plurality of upgrade steps and storing, in the partition, information pertaining to the execution of the upgrade. In some embodiments, self-correction information can be stored in the partition. In some embodiments, user-relevant information can be stored in the partition or in a second partition that was excluded from the snapshot. User-relevant information can include, for instance, a log corresponding to the execution of the upgrade. A flag file can be stored in the partition. The flag file can indicate that a reversion is to take place. Stated differently, the flag file can indicate (or trigger) a reversion to the snapshot.

At 222, the method includes reverting to the snapshot responsive to a cancellation of the upgrade. In some embodiments, the cancellation is caused by a user. In some embodiments, the cancellation is not caused by a user but by some failure in the upgrade process. Some embodiments include the provision of the user-relevant information to a user interface responsive to the reversion. In some embodiments, the VCI is restarted following the reversion. The cancellation of the upgrade can cause the log corresponding to the execution of the upgrade to be provided to a user interface. With the log, a user can determine what may have gone wrong with the upgrade and can take various actions to cure whatever deficiencies may be present.

At 224, the method includes re-executing the upgrade of the VCI from the snapshot, wherein re-executing the upgrade includes performing a different plurality of upgrade steps determined based on the information pertaining to the execution of the upgrade. Some embodiments include performing a check for the flag file. If the flag file is present, the upgrade can be re-executed. Stated differently, some embodiments include re-executing the upgrade of the VCI from the snapshot responsive to determining that the flag file is stored in the partition. In some embodiments a cleanup operation may be performed so that a new snapshot can be taken. The re-execution can operate using the knowledge of what may have caused the upgrade to fail because that information was kept in the partition and excluded from the snapshot.

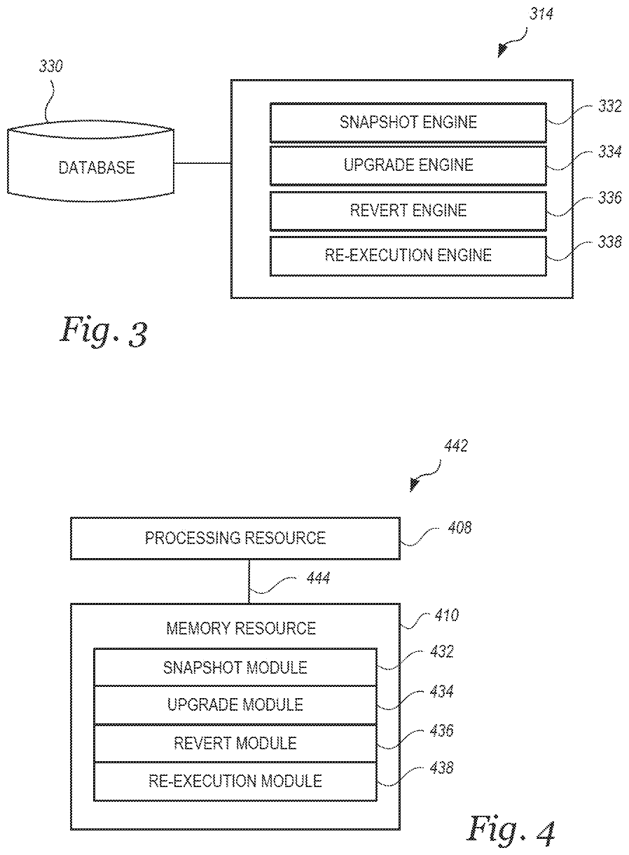

FIG. 3 is a diagram of a system 314 for unattended snapshot reversion for upgrades according to one or more embodiments of the present disclosure. The system 314 can include a database 330 and/or a number of engines, for example snapshot engine 332, upgrade engine 334, revert engine 336, and/or re-execution engine 338, and can be in communication with the database 330 via a communication link. The system 314 can include additional or fewer engines than illustrated to perform the various functions described herein. The system can represent program instructions and/or hardware of a machine (e.g., machine 442 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the snapshot engine 332 can include a combination of hardware and program instructions that is configured to create a snapshot of a virtual computing instance (VCI) in a software-defined datacenter (SDDC) responsive to receiving a request to upgrade the VCI, wherein the snapshot excludes a first predefined storage partition associated with the VCI and a second predefined storage partition associated with the VCI. In some embodiments, the upgrade engine 334 can include a combination of hardware and program instructions that is configured to execute an upgrade of the VCI. The upgrade can include performing a plurality of upgrade steps, storing, in the first partition, self-correction information pertaining to the execution of the upgrade, and storing, in the second partition, user-relevant information pertaining to the execution of the upgrade. In some embodiments, the revert engine 336 can include a combination of hardware and program instructions that is configured to revert to the snapshot responsive to a cancellation of the upgrade. In some embodiments, the re-execution engine 338 can include a combination of hardware and program instructions that is configured to re-execute the upgrade of the VCI from the snapshot, wherein re-executing the upgrade includes performing a different plurality of upgrade steps determined based on the self-correction information pertaining to the execution of the upgrade.

FIG. 4 is a diagram of a machine for unattended snapshot reversion for upgrades according to one or more embodiments of the present disclosure. The machine 442 can utilize software, hardware, firmware, and/or logic to perform a number of functions. The machine 442 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 442 (e.g., the machine 442 can include internal memory resources and have access to external memory resources). In some embodiments, the machine 442 can be a virtual computing instance (VCI). The program instructions (e.g., machine-readable instructions (MRI)) can include instructions stored on the MRM to implement a particular function (e.g., an action such as reverting to a snapshot as described herein). The set of MRI can be executable by one or more of the processing resources 408. The memory resources 410 can be coupled to the machine 442 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 408 can be coupled to the memory resources 410 via a communication path 444. The communication path 444 can be local or remote to the machine 442. Examples of a local communication path 444 can include an electronic bus internal to a machine, where the memory resources 410 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 444 can be such that the memory resources 410 are remote from the processing resources 408, such as in a network connection between the memory resources 410 and the processing resources 408. That is, the communication path 444 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 432, 434, 436, 438 that when executed by the processing resources 408 can perform a number of functions. As used herein a module includes a set of instructions included to perform a particular task or action. The number of modules 432, 434, 436, 438 can be sub-modules of other modules. For example, the re-execution module 438 can be a sub-module of the revert module 436 and/or can be contained within a single module. Furthermore, the number of modules 432, 434, 436, 438 can comprise individual modules separate and distinct from one another. Examples are not limited to the specific modules 432, 434, 436, 438 illustrated in FIG. 4.

Each of the number of modules 432, 434, 436, 438 can include program instructions and/or a combination of hardware and program instructions that, when executed by a processing resource 408, can function as a corresponding engine as described with respect to FIG. 3. For example, the revert module 436 can include program instructions and/or a combination of hardware and program instructions that, when executed by a processing resource 408, can function as the revert engine 336, though embodiments of the present disclosure are not so limited.

The machine 442 can include a snapshot module 432, which can include instructions to create a snapshot of a virtual computing instance (VCI) in a software-defined datacenter (SDDC) responsive to receiving a request to upgrade the VCI, wherein the snapshot excludes a first predefined storage partition associated with the VCI and a second predefined storage partition associated with the VCI. The machine 442 can include an upgrade module 434, which can include instructions to execute an upgrade of the VCI, wherein executing the upgrade includes performing a plurality of upgrade steps, storing, in the first partition, self-correction information pertaining to the execution of the upgrade, and storing, in the second partition, user-relevant information pertaining to the execution of the upgrade. The machine 442 can include a revert module 436, which can include instructions to revert to the snapshot responsive to a cancellation of the upgrade. The machine 442 can include a re-execution module 438, which can include instructions to re-execute the upgrade of the VCI from the snapshot, wherein re-executing the upgrade includes performing a different plurality of upgrade steps determined based on the self-correction information pertaining to the execution of the upgrade.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a request to upgrade a virtual computing instance (VCI) in a software-defined datacenter (SDDC):
creating a snapshot of the VCI, wherein the snapshot excludes a predefined storage partition associated with the VCI;
executing an upgrade of the VCI, wherein executing the upgrade includes performing a plurality of upgrade steps and storing, in the partition, information pertaining to the execution of the upgrade;
reverting to the snapshot responsive to a cancellation of the upgrade; and
re-executing the upgrade of the VCI from the snapshot, wherein re-executing the upgrade includes performing a different plurality of upgrade steps determined based on the information pertaining to the execution of the upgrade.

2. The method of claim 1, wherein the method includes creating the snapshot of the VCI by the VCI.

3. The method of claim 1, wherein the method includes storing, in the partition, information pertaining to the execution of the upgrade while the upgrade is being executed.

4. The method of claim 1, wherein the information pertaining to the execution of the upgrade includes a log corresponding to the execution of the upgrade.

5. The method of claim 4, wherein the method includes providing the log to a user interface responsive to the cancellation of the upgrade.

6. The method of claim 1, wherein the cancellation was caused by a user input.

7. The method of claim 1, wherein the cancellation was caused by a failure of the execution of the upgrade.

8. The method of claim 1, wherein the method includes providing a reversion notification responsive to another cancellation of upgrade following the reversion.

9. The method of claim 1, wherein the method includes providing an upgrade notification responsive to a completion of the upgrade.

10. A non-transitory machine-readable medium having instructions stored thereon which, when executed by a processor, cause the processor to:
create a snapshot of a virtual computing instance (VCI) in a software-defined datacenter (SDDC) responsive to receiving a request to upgrade the VCI, wherein the snapshot excludes a first predefined storage partition associated with the VCI and a second predefined storage partition associated with the VCI;
execute an upgrade of the VCI, wherein executing the upgrade includes:
performing a plurality of upgrade steps;
storing, in the first partition, self-correction information pertaining to the execution of the upgrade; and
storing, in the second partition, user-relevant information pertaining to the execution of the upgrade;
revert to the snapshot responsive to a cancellation of the upgrade; and
re-execute the upgrade of the VCI from the snapshot, wherein re-executing the upgrade includes performing a different plurality of upgrade steps determined based on the self-correction information pertaining to the execution of the upgrade.

11. The medium of claim 10, including instructions to provide the user-relevant information to a user interface responsive to the reversion.

12. The medium of claim 10, including instructions to store, in the first partition, a flag file indicating the reversion to the snapshot.

13. The medium of claim 12, including instructions to restart the VCI subsequent to the reversion to the snapshot and perform a check for the flag file.

14. The medium of claim 13, including instructions to re-execute the upgrade of the VCI from the snapshot responsive to determining that the flag file is stored in the first partition.

15. The medium of claim 10, wherein the user-relevant information pertaining to the execution of the upgrade includes a log corresponding to the execution of the upgrade.

16. The medium of claim 15, including instructions to provide the log to a user interface responsive to the cancellation of the upgrade.

17. The medium of claim 10, wherein the instructions to create the snapshot of the VCI are executable by the VCI.

18. The medium of claim 10, wherein the snapshot is a VCI snapshot or a Logical Volume Manager (LVM) snapshot.

19. A system, comprising:
a snapshot engine configured to create a snapshot of a virtual computing instance (VCI) in a software-defined datacenter (SDDC) responsive to receiving a request to upgrade the VCI, wherein the snapshot excludes a first predefined storage partition associated with the VCI and a second predefined storage partition associated with the VCI;
an upgrade engine configured to execute an upgrade of the VCI, wherein executing the upgrade includes:
performing a plurality of upgrade steps;
storing, in the first partition, self-correction information pertaining to the execution of the upgrade; and
storing, in the second partition, user-relevant information pertaining to the execution of the upgrade;
a revert engine configured to revert to the snapshot responsive to a cancellation of the upgrade; and
a re-execution engine configured to re-execute the upgrade of the VCI from the snapshot, wherein re-executing the upgrade includes performing a different plurality of upgrade steps determined based on the self-correction information pertaining to the execution of the upgrade.

20. The system of claim 18, wherein the re-execution engine is configured to restart the VCI after reversion to the snapshot.

21. The system of claim 18, wherein the re-execution engine is configured to re-execute the upgrade of the VCI responsive to a determination that a flag file is present in the first partition.
